(19) United States
(12) Patent Application Publication
(10) Pub. No.: US 2014/0222801 A1
(43) Pub. Date: Aug. 7, 2014

(54) AUTONOMIC SELECTIVE IMPORTATION OF CONTACTS IN A CONTACT MANAGEMENT SYSTEM

(71) Applicant: SUGARCRM INC., Cupertino, CA (US)

(72) Inventor: Majed Itani, San Jose, CA (US)

(73) Assignee: SugarCRM Inc., Cupertino, CA (US)

(21) Appl. No.: 13/757,926

(22) Filed: Feb. 4, 2013

(51) Int. Cl. G06F 17/30; H04L 12/26

(52) U.S. Cl. CPC G06F 17/30554; H04L 12/2602
USPC 707/727; 709/224

(57) ABSTRACT

Embodiments of the present invention provide a method, system and computer program product for autonomic selective importation of contacts in a contact management system. In one embodiment of the invention, a method for autonomic selective importation of contacts in a contact management system is provided. The method includes monitoring communications between an end user and different contacts over a communications network through at least one external communications application and rating the different contacts according to frequency of communication with the end user evident from the monitored communications. The method additionally includes importing a selected one of the different contacts into a contact data store of a contact management system responsive to a determination that the selected one of the different contacts has been rated beyond a threshold value.

### BACKGROUND OF THE INVENTION

1. Field of the Invention

The present invention relates to contact management more particularly to selectively importing contacts from external sources into a contact management system.

2. Description of the Related Art

A contact management system is a computer program configured at the minimum to store and manage information for different contacts that can include either individuals or organizations of individuals. The most basic form of the contact management system is an electronic address book. More advanced forms of the contact management system are found as embedded components of more sophisticated information systems such as calendaring and scheduling (C&S) systems, invoicing and billing systems, and customer relationship management (CRM) systems.

Generally, contact management systems require the end user to manually key in information for contacts of interest. Some contact management systems provides automated contact information entry through the scanning of business card data or the importation of electronic business card data such as the venerable “vCard”. Frequently, however, contact information for different contacts already stored within the contact management system change. In the event of a change to contact information, the end user is required to manually apply the changes to the contact information.

For many decades, end users tracked contact information only within a single contact management system. However, the advent of the global Internet and social networking has provided multiple different sources for contact information for the same contact. As such, maintaining changes for an individual contact in multiple different contact management systems of different applications including those disposed within mobile telephones, personal digital assistants, social networks and enterprise applications, can be a tedious task, to say the least.

To address this difficulty, advanced contact management systems actively integrate with different applications and social networks to maintain synchronicity of contact information for common contacts automatically. For instance, it is widely known in the mobile telephony arts to automatically import contacts from different social networks and remote C&S systems into a contact management system for a mobile telephone. Further, it is known to continuously apply changes to contact information detected in those social networks and remote C&S systems to the contact management system for the mobile telephone thereby relieving the end user of the task of even detecting those changes in contact information.

Notwithstanding, blindly importing contact information from social networks and other remote C&S systems can lead to the undesirable mixing of personal and business contact information and can clog the contact information data store of an enterprise information system with contact information for contacts not related to the underlying business supported by the enterprise information system. It is true that some importation routines permit the manual selection of those contacts to import or update into the contact management system, however, for a contact management system supporting multiple end users and hundreds if not thousands of contacts, manually selecting updates to contact information can be unmanageable.

### BRIEF SUMMARY OF THE INVENTION

Embodiments of the present invention address deficiencies of the art in respect to contact information synchronization and provide a novel and non-obvious method, system and computer program product for autonomic selective importation of contacts in a contact management system. In one embodiment of the invention, a method for autonomic selective importation of contacts in a contact management system is provided. The method includes monitoring communications between an end user and different contacts over a communications network through at least one external communications application and rating the different contacts according to frequency of communication with the end user evident from the monitored communications. The method additionally includes importing a selected one of the different contacts into a contact data store of a contact management system responsive to a determination that the selected one of the different contacts has been rated beyond a threshold value.

In another embodiment of the invention, a contact management data processing system can be configured for autonomic selective importation of contacts. The system can include a host computer with memory and at least one processor, a contact management system executing in the host computer, a contact data store coupled to the contact management system and an external communications application also executing in the host computer. The system additionally can include a selective contact importation module coupled to the contact management system. The module can include program code that when executed in the memory of the host computer, monitors communications between an end user and different contacts over a communications network through the external communications application, rates the different contacts according to frequency of communication with the end user evident from the monitored communications, and imports a selected one of the different contacts into the contact data store responsive to a determination that the selected one of the different contacts has been rated beyond a threshold value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for autonomic selective importation of contacts in a contact management system;

FIG. 2 is a schematic illustration of a contact management data processing system configured for autonomic selective importation of contacts; and,

FIG. 3 is a flow chart illustrating a process for autonomic selective importation of contacts in a contact management system.

### DETAILED DESCRIPTION OF THE INVENTION

Embodiments of the invention provide for autonomic selective importation of contacts in a contact management system. In accordance with an embodiment of the invention, interactions conducted with different communications applications with different contacts over a communications network can be monitored. A frequency of interaction with each of the different contacts can be computed and contacts determined to have a frequency of interaction that exceeds a threshold value can be automatically imported into the contact management system. Optionally, the determination of whether or not to import a contact into the contact management system can be influenced for contacts included in interactions that also implicate at least one other contact already stored in the contact management system. As yet another option, the determination of whether or not to import a contact into the contact management system can be influenced according to recognized content or patterns of content of the interactions involving the contact.

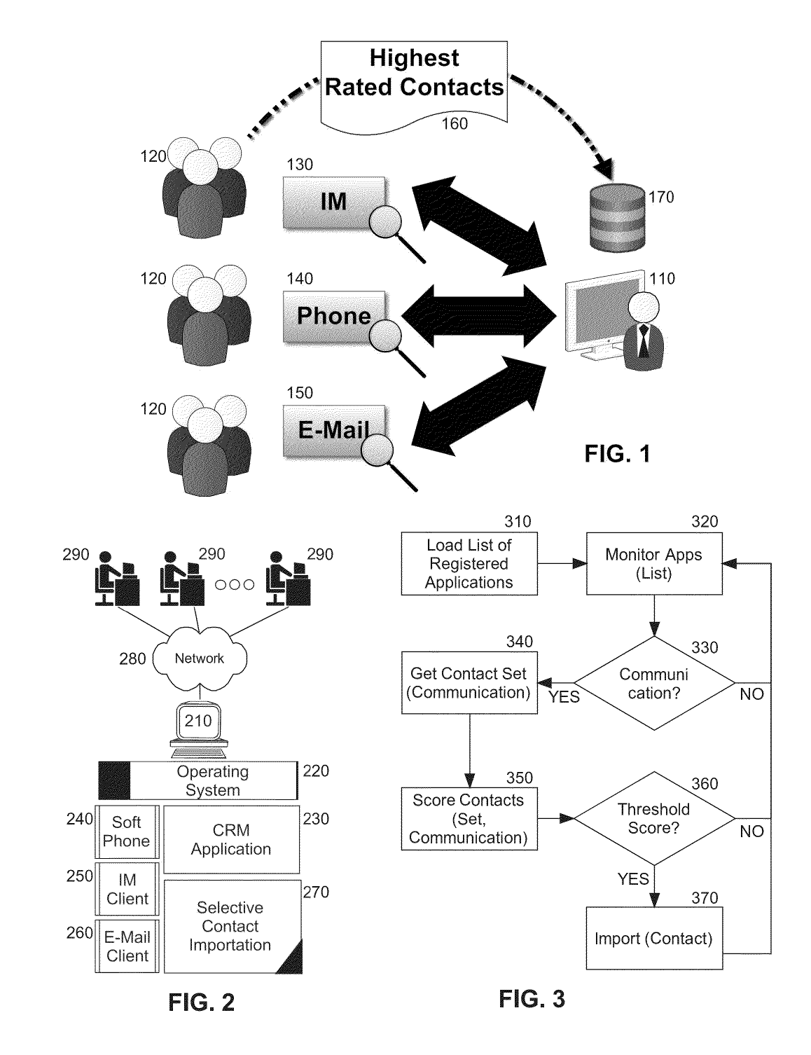

In further illustration, FIG. 1 pictorially shows a process for autonomic selective importation of contacts in a contact management system. As shown in FIG. 1, communications 130, 140, 150 between an end user 110 and other contacts 120 can be monitored in order to determine a frequency of communicative interaction between the end user 110 and each of the contacts 120. For instance, an e-mail application 150 can be monitored to detect messages exchanged between the end user 110 and one or more of the contacts 120, an instant messenger 130 can be monitored to detect messages exchanged between the end user 110 and one or more of the contacts 120, and even a phone application 140, whether embedded in a mobile phone or included as a soft phone on a personal computer, can be monitored to detect phone calls established between the end user 110 and one or more of the contacts 120.

A frequency of interaction between the end user 110 and different ones of the contacts 120 can be computed responsive to each detected communication between the end user 110 and the different ones of the contacts 120. Individual ones of the contacts 120 determined to interact with the end user with sufficient frequency can be assigned a highest rating 160. Thereafter, contacts 120 with the highest rating 160 can be imported into a data store 170 of contacts for a corresponding contact management system, such as that disposed within a CRM application. Other contacts 120 not assigned the highest rating 160 can be excluded from importation into the data store 170 of contacts.

Of note, the highest rating 160 for a particular one of the contacts 120 can be influenced in addition to a frequency of communication with the end user 110 according to whether or not communications 130, 140, 150 between the end user 110 and the particular one of the contacts 120 occurs in connection with a different one of the contacts 120 already disposed within the data store 170 of contacts, or whether the end user 110 and the particular one of the contacts 120 shares a common employer. Additionally, the highest rating 160 for a particular one of the contacts 120 can be influenced according to one or more rules such as rules preferring one form of the communications 130, 140, 150. For instance, a communication occurring by way of a phone application 140 may accorded more weight than a communication occurring by way of an e-mail application 150. Even further, the rules can specify a higher rating for a particular one of the contacts 120 based upon words detected within the communications 130, 140, 150.

The process described in connection with FIG. 2 can be implemented within a contact management data processing system. In yet further illustration, FIG. 2 is a schematic illustration showing a contact management data processing system configured for autonomic selective importation of contacts. The system can include a host computer 210 with an operating system 220 that is configured for communicative coupling to different contacts 290 over a computer communications network 280. The operating system 220 can host the execution of a CRM application 230, as well as separate communications applications such as a soft phone 240, an instant messenger 250 and an e-mail client 260. Selective contact importation module 270 can be coupled to the CRM application 230 and can execute in memory of the host computer 210.

The module 270 can include program code that when executed by a processor of the host computer 210, can monitor communications in the soft phone 240, instant messenger 250 and e-mail client 260 to measure a frequency of communication with individual ones of the contacts 290. Additionally, the program code of the module 270 can measure a context for the communications with the individual ones of the contacts 290 including words used in the communications, an employer associated with the individual ones of the contacts 290, others of the contacts 290 includes in the communications, and the like. Thereafter, each of the contacts 290 associated with one or more of the communications can be scored and those of the contacts 290 with a score that exceeds a threshold value can be added to a data store of contacts for the CRM application 230.

In even yet further illustration of the operation of the module 270, FIG. 3 is a flow chart illustrating a process for autonomic selective importation of contacts in a contact management system. Beginning in block 310, a list of registered applications for which communications can be exchanged between an end user and other contacts can be loaded and in block 320, each of the applications in the list can be monitored to detect new communications. In block 330, it can be determined whether or not a new communications has occurred, such as an outbound or inbound message or an outbound or inbound telephone call. If so, in block 340, one or more contacts associated with the detected communication can be identified including contacts listed as a message recipient in a message, or contacts included as part of a conference call.

In block 350, each of the contacts associated with the detected message can be scored based upon a frequency of communications associated with each of the contacts. Optionally, the context of the communications can be used to influence the scoring, such as the words used in the communications triggering a higher score, or the identity of other contacts associated with the communications triggering a higher score, or the identity of an employer for the contacts associated with the communications triggering a higher score. Thereafter, in decision block 360, if the score for any of the contacts exceeds a threshold value, in block 370 those of the contacts with a threshold exceeding score can be added to a contacts database for a contact management system. Subsequently, the process can return to block 320.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for autonomic selective importation of contacts in a contact management system, the method comprising:
monitoring communications between an end user and different contacts over a communications network through at least one external communications application;
rating the different contacts according to frequency of communication with the end user evident from the monitored communications; and,
importing a selected one of the different contacts into a contact data store of a contact management system responsive to a determination that the selected one of the different contacts has been rated beyond a threshold value.

2. The method of claim 1, wherein the external communications application is an e-mail application.

3. The method of claim 1, wherein the external communications application is an instant messenger.

4. The method of claim 1, wherein the external communications application is phone application.

5. The method of claim 1, wherein a rating for the selected one of the different contacts is enhanced responsive to a determination that a corresponding communication also is received by a different contact already present in the contact data store.

6. The method of claim 1, wherein a rating for the selected one of the different contacts is enhanced responsive to a detection of a specified word in a corresponding communication.

7. The method of claim 1, wherein the contact management system is included as part of a customer relationship management (CRM) application.

8. A contact management data processing system configured for autonomic selective importation of contacts, the system comprising:
a host computer with memory and at least one processor;
a contact management system executing in the host computer;
a contact data store coupled to the contact management system;
an external communications application also executing in the host computer; and,
a selective contact importation module coupled to the contact management system, the module comprising program code that when executed in the memory of the host computer, monitors communications between an end user and different contacts over a communications network through the external communications application, rates the different contacts according to frequency of communication with the end user evident from the monitored communications, and imports a selected one of the different contacts into the contact data store responsive to a determination that the selected one of the different contacts has been rated beyond a threshold value.

9. The system of claim 8, wherein the external communications application is an e-mail application.

10. The system of claim 8, wherein the external communications application is an instant messenger.

11. The system of claim 8, wherein the external communications application is phone application.

12. The system of claim 8, wherein a rating for the selected one of the different contacts is enhanced responsive to a determination that a corresponding communication also is exchanged with a different contact already present in the contact data store.

13. The system of claim 8, wherein a rating for the selected one of the different contacts is enhanced responsive to a detection of a specified word in a corresponding communication.

14. The system of claim 8, wherein the contact management system is included as part of a customer relationship management (CRM) application.

15. A computer program product for autonomic selective importation of contacts in a contact management system, the computer program product comprising:
a computer readable storage medium having computer readable program code embodied therewith, the computer readable program code comprising:
computer readable program code for monitoring communications between an end user and different contacts over a communications network through at least one external communications application;
computer readable program code for rating the different contacts according to frequency of communication with the end user evident from the monitored communications; and,
computer readable program code for importing a selected one of the different contacts into a contact data store of a contact management system responsive to a determination that the selected one of the different contacts has been rated beyond a threshold value.

16. The computer program product of claim 15, wherein the external communications application is an e-mail application.

17. The computer program product of claim 15, wherein the external communications application is an instant messenger.

18. The computer program product of claim 15, wherein the external communications application is phone application.

19. The computer program product of claim 15, wherein a rating for the selected one of the different contacts is enhanced responsive to a determination that a corresponding communication also is exchanged with a different contact already present in the contact data store.

20. The computer program product of claim 15, wherein a rating for the selected one of the different contacts is enhanced responsive to a detection of a specified word in a corresponding communication.

21. The computer program product of claim 15, wherein the contact management system is included as part of a customer relationship management (CRM) application.
